(19) United States
(12) Patent Application Publication
(10) Pub. No.: US 2024/0393499 A1
(43) Pub. Date: Nov. 28, 2024

(54) MULTI-DIMENSIONAL FEATURE IDENTIFICATION METHOD AND SYSTEM OF DISASTER-CAUSING CYCLONES

(71) Applicant: Nanjing University of Information Science & Technology, Nanjing (CN)

(72) Inventors: Yanjun Wang, Nanjing (CN); Jinlong Huang, Nanjing (CN); Tong Jiang, Nanjing (CN); Jianqing Zhai, Beijing (CN); Buda Su, Nanjing (CN); Haifeng Yang, Nanjing (CN)

(21) Appl. No.: 18/668,265

(22) Filed: May 20, 2024

(30) Foreign Application Priority Data
May 24, 2023 (CN) 202310589703.1

(51) Int. Cl. G01W 1/10

(52) U.S. Cl. CPC G01W 1/10; Y02A 10/40

(57) ABSTRACT

A multi-dimensional feature identification method of a disaster-causing cyclone includes: determining a disaster-causing range based on a path of the disaster-causing cyclone, dividing the disaster-causing range into multiple grid points, obtaining meteorological data including wind speeds and rainfall amounts of the grid points within the disaster-causing range; determining, based on historical typhoon data, disaster-causing thresholds including a wind speed disaster-causing threshold and a rainfall disaster-causing threshold for the meteorological data; constructing a multi-dimensional feature database for disaster-causing events; and performing multi-dimensional feature identification on the disaster-causing cyclone based on the multi-dimensional feature database for disaster-causing events. The method can identify features of the disaster-causing cyclone at each moment and in multiple dimensions, which provides technical support for further accurate evaluation of socio-economic exposure and vulnerability of the disaster-causing cyclone.

### TECHNICAL FIELD

The disclosure relates to the field of meteorological disaster early warning, particularly to a multi-dimensional feature identification method and system of disaster-causing cyclones.

### BACKGROUND

According to statistics, there are 81 tropical cyclones in the world every year, which are mainly distributed in six sea areas: the northwest Pacific, the northeast Pacific, the north Atlantic Ocean, the south Indian Ocean, the south Pacific and the north Indian Ocean. Disaster-causing cyclones can adversely affect human life, property or various activities (especially in coastal areas) and bring direct economic losses. The disaster-causing cyclone is a dynamic process and regional phenomenon, which mainly affects people's production and life through disaster-causing factors such as strong wind, heavy rainfall and storm surge brought by cyclone, and has features of sudden and destructive power. Nowadays, the threat of tropical cyclones to life and property has increased obviously under the background of global warming, and studying the features of disaster-causing cyclone is conducive to correctly understanding the temporal and spatial evolution law of disaster-causing cyclones and has important practical significance for disaster early warning.

In the related art, the research on the features of disaster-causing cyclones includes cyclone path, central air pressure, near-surface maximum wind speed, disaster loss, etc., but there is a lack of a method to identify an influence range and intensity of near-surface gale and heavy rainfall caused by a certain disaster-causing cyclone on a time scale, and accurately give the influence range and duration of the disaster-causing cyclone. Therefore, a multi-dimensional feature identification method of “path-influence range-intensity change-duration” of disaster-causing cyclones is needed to identify the features of the disaster causing cyclones at every moment and in multiple dimensions.

### SUMMARY

The purpose of the disclosure is to provide a multi-dimensional feature identification method and system of disaster-causing cyclones, which at least partially solve the problems in the related art.

In the first aspect, the disclosure provides a multi-dimensional feature identification method of a disaster-causing cyclone, which includes the following steps:
determining a disaster-causing range based on a path of the disaster-causing cyclone, dividing the disaster-causing range into multiple grid points, and obtaining meteorological data of the grid points within the disaster-causing range; where the meteorological data of the grid points includes a wind speed of each grid point and a rainfall amount of each grid point;
determining, based on historical typhoon data, disaster-causing thresholds for the meteorological data of the grid points; where the disaster-causing thresholds include: a wind speed disaster-causing threshold and a rainfall disaster-causing threshold;
constructing a multi-dimensional feature identification model of the disaster-causing cyclone by using the disaster-causing thresholds, the disaster-causing range, and the meteorological data of the grid points, which includes: marking the grid points whose wind speeds each exceed the wind speed disaster-causing threshold as wind-exceeding grid points, grouping the consecutive wind-exceeding grid points into a same area to form multiple extreme wind speed influence areas, marking the grid points whose rainfall amounts each exceed the rainfall disaster-causing threshold as rain-exceeding grid points, grouping the consecutive rain-exceeding grid points into a same area to form multiple extreme rainfall influence areas, determining whether the wind speed and the rainfall amount of each grid point respectively exceed the wind speed disaster-causing threshold and the rainfall disaster-causing threshold at each moment according to the disaster-causing range until no extreme wind speed influence area and no extreme rainfall influence area appear at a certain moment, and obtaining a duration of the disaster-causing cyclone based on a number of determined moments; and
constructing a multi-dimensional feature database for disaster-causing events based on the extreme wind speed influence areas, the extreme rainfall influence areas, the duration, and the path; and performing multi-dimensional feature identification on the disaster-causing cyclone based on the multi-dimensional feature database for disaster-causing events.

According to the method, the disaster-causing thresholds are determined by the historical typhoon data, and the multi-dimensional feature identification model of the disaster-causing cyclone is constructed by using the disaster-causing range, the disaster-causing thresholds and the meteorological data. By using the multi-dimensional feature identification model, the influence range and intensity of near-surface gale and heavy rainfall caused by the disaster-causing cyclone can be identified on a time scale, and the influence range, duration and intensity change of the disaster-causing cyclone can be accurately given, thus providing technical support for further accurately evaluating the socio-economic exposure and vulnerability of the disaster-causing cyclone.

In an alternative embodiment, the multi-dimensional feature identification method further includes: obtaining an influence range and an intensity change of the disaster-causing cyclone through performing the multi-dimensional feature identification on the disaster-causing cyclone, thereby providing early warning based on the influence range and the intensity change of the disaster-causing cyclone to people living in the influence range. In addition, the short-term early warning can serve emergency management and response, and the multi-dimensional feature identification method further includes: performing future risk assessment to obtain risk assessment results, and the risk assessment results can provide support for the relevant staff to formulate management measures and policies.

In an alternative embodiment, the determining, based on historical typhoon data, disaster-causing thresholds for the meteorological data, includes:
calculating the wind speed disaster-causing threshold through the following formula:

$${V}_{t} = {[ \frac{L}{E ( {P}^{b} + {G}^{c} )} \times {e}^{\frac{D}{{a}^{\text{?}}}} ]}^{\frac{1}{a}} ,$$

$$\text{?} \text{indicates text missing or illegible when filed}$$

where Vₜ represents the wind speed disaster-causing threshold, L represents a direct economic loss caused by typhoon, E represents an economic exposure of the disaster-causing cyclone, P represents a rainfall amount corresponding to wind speed disaster-causing grid points,

$$P = \frac{1}{N} {{\sum }_{i = 1}}^{N} {P}_{i} ,$$

N represents a total number of the wind speed disaster-causing grid points, Pᵢ represents a rainfall amount corresponding to an i-th wind speed disaster-causing grid point of the wind speed disaster-causing grid points, G represents a total production value, D is a constant, and a, b, and c are correlation coefficients.
calculating the rainfall disaster-causing threshold through the following formula:

$${P}_{t} = {[ \frac{L}{E ( {V}^{a} + {G}^{c} )} \times {e}^{\frac{D}{{b}^{2}}} ]}^{\frac{1}{b}} ,$$

where Pₜ represents the rainfall disaster-causing threshold, V represents a wind speed corresponding to rainfall disaster-causing grid points,

$$V = \frac{1}{M} {{\sum }_{j = 1}}^{M} {V}_{j} ,$$

M represents a total number of the rainfall disaster-causing grid points, Vⱼ represents a wind speed corresponding to a j-th rainfall disaster-causing grid point of the rainfall disaster-causing grid points, and F is a constant.

By dividing the grid points, the wind speed disaster-causing grid points and the rainfall disaster-causing grid points are obtained according to the influence range of typhoon, and the influence of rainfall on the grid points is considered according to the actual situation of typhoon disaster when calculating the wind speed disaster-causing threshold, and the influence of wind speed on the grid points is considered according to the actual situation of typhoon disaster when calculating the rainfall disaster-causing threshold. Its advantages are that the influence of rainfall is not needed when evaluating the disaster caused by wind speed of the disaster-causing cyclone, and the influence of wind speed is not needed when evaluating the disaster caused by rainfall of the disaster-causing cyclone.

In an alternative embodiment, the constructing a multi-dimensional feature identification model of the disaster-causing cyclone by using the disaster-causing thresholds, the disaster-causing range, and the meteorological data, further includes:
extracting composite event areas and single event areas based on the extreme wind speed influence areas and the extreme rainfall influence areas; the composite event areas respectively are overlapping areas between the extreme wind speed influence areas and the extreme rainfall influence areas, and the single event areas respectively are non-overlapping areas between the extreme wind speed influence areas and the extreme rainfall influence areas.

As the single event area only under the influence of wind speed or rainfall is quite different from the composite event area under the joint influence of wind speed and rainfall, the disclosure further identifies and extracts the single event areas and the composite event areas according to the extreme wind speed influence areas and the extreme rainfall influence areas, so as to determine the wind speed and rainfall conditions in the single event areas and the composite event areas respectively, which is beneficial to more carefully reflecting the influence degree of the disaster-causing cyclone on different areas and the intensity change of the disaster-causing cyclone.

In an alternative embodiment, the constructing a multi-dimensional feature identification model of the disaster-causing cyclone by using the disaster-causing thresholds, the disaster-causing range, and the meteorological data, further includes:
calculating a composite extreme wind speed of each composite event area and a single extreme wind speed of each single event area based on the wind speeds of the wind-exceeding grid points; and the composite extreme wind speed of each composite event area and the single extreme wind speed of each single event area respectively satisfy the following relationships:

$${v}_{c} = \frac{1}{{N}_{1}} {\sum }_{i = 1}^{{N}_{1}} {v}_{ci} - {[ \frac{1}{{N}_{1}} {\sum }_{i = 1}^{{N}_{1}} {( {v}_{ci} - \frac{1}{{N}_{1}} {\sum }_{i = 1}^{{N}_{1}} {v}_{ci} )}^{2} ]}^{\frac{1}{2}} ; \\ {v}_{s} = \frac{1}{{M}_{1}} {\sum }_{j = 1}^{{M}_{1}} {v}_{sj} - {[ \frac{1}{{M}_{1}} {\sum }_{j = 1}^{{M}_{1}} {( {v}_{sj} - \frac{1}{{M}_{1}} {\sum }_{j = 1}^{{M}_{1}} {v}_{sj} )}^{2} ]}^{\frac{1}{2}} ;$$

where v_{c} represents the composite extreme wind speed, N₁ represents a number of grid points in the composite event area, v_{ci} represents a wind speed of an i-th grid point in the composite event area; vₛ represents the single extreme wind speed, M₁ represents a number of grid points of the single event area in the extreme wind influence area, and vₛⱼ represents a wind speed of a j-th grid point of the single event area in the extreme wind influence area;
calculating a composite extreme rainfall amount of each composite event area and a single extreme rainfall amount of each single event area based on the rainfall amounts of the rain-exceeding grid points; and the composite extreme rainfall amount of each composite event area and the single extreme rainfall amount of each single event area respectively satisfy the following relationships:

$${p}_{c} = \frac{1}{{N}_{2}} {\sum }_{i = 1}^{{N}_{2}} {p}_{ci} - {[ \frac{1}{{N}_{2}} {\sum }_{i = 1}^{{N}_{2}} {( {p}_{c \text{?}} - \frac{1}{{N}_{2}} {\sum }_{i = 1}^{{N}_{2}} {p}_{\text{?} i} )}^{2} ]}^{\frac{1}{2}} ; \\ {p}_{s} = \frac{1}{{M}_{2}} {\sum }_{j = 1}^{{M}_{\text{?}}} {p}_{\text{?} j} - {[ \frac{1}{{M}_{2}} {\sum }_{j = 1}^{{M}_{2}} {( {p}_{sj} - \frac{1}{{M}_{2}} {\sum }_{j = 1}^{{M}_{2}} {p}_{sj} )}^{2} ]}^{\frac{1}{2}} ;$$

$$\text{?} \text{indicates text missing or illegible when filed}$$

where p_{c} represents the composite extreme rainfall amount, N₂ represents a number of grid points in the composite event area, p_{c} represents a rainfall amount of the i-th grid point in the composite event area, pₛ represents the single extreme rainfall amount, M₂ represents a number of grid points of the single event area in the extreme rainfall influence area, and pₛⱼ represents a rainfall amount of the j-th grid point of the single extreme area in the extreme rainfall influence area.

When calculating the composite extreme wind speed, the single extreme wind speed, the composite extreme rainfall amount and the single extreme rainfall amount, the disclosure does not consider the mutual influence between the wind speed and the rainfall, thus simplifying the calculation steps without affecting the accuracy of the calculation result and improving the calculation efficiency.

In an alternative embodiment, the method further includes:
constructing a multi-dimensional feature database for composite disaster-causing events based on the composite event areas; and
constructing a multi-dimensional feature database for single disaster-causing events based on the single event areas.

In an alternative embodiment, the constructing a multi-dimensional feature database for composite disaster-causing events based on the composite event areas, includes:
sequentially numbering the composite event areas along the path to obtain a first set of numbers;
sequentially obtaining, based on the first set of numbers, a size of each composite event area, the composite extreme wind speed and the composite extreme rainfall amount of each composite event area;
constructing multiple feature subsets for the composite event areas based on the composite event areas, the size of each composite event area, the composite extreme wind speed and the composite extreme rainfall amount of each composite event area; and
constructing the multi-dimensional feature database for composite disaster-causing events based on the feature subsets for the composite event areas, the path and the duration.

In an alternative embodiment, the constructing a multi-dimensional feature database for single disaster-causing events based on the single event areas, includes:
sequentially numbering the single event areas along the path to obtain a second set of numbers;
sequentially obtaining, based on the second set of numbers, a size of each single event area, the single extreme wind speed and the single extreme rainfall amount of each single event area;
constructing multiple feature subsets for the single event areas based on the single event areas, the size of each single event area, the single extreme wind speed and the single extreme rainfall amount of each single event area; and
constructing the multi-dimensional feature database for single disaster-causing events based on the feature subsets for the single event areas, the path and the duration.

According to the disclosure, by constructing the multi-dimensional feature database for composite disaster-causing events and the multi-dimensional feature database for single disaster-causing events, the obtained data of the composite event areas are collected together, and the obtained data of the single event areas are collected together, so that the obtained data are clearer and more convenient to quickly identify the multi-dimensional features of the disaster-causing cyclone.

In the second aspect, the disclosure provides a multi-dimensional feature identification system of a disaster-causing cyclone, which includes: a data obtaining module, a threshold determining module, a data processing module, and a data outputting module.

The data obtaining module is configured to determine a disaster-causing range based on a path of the disaster-causing cyclone, divide the disaster-causing range into multiple grid points, and obtain meteorological data of the grid points within the disaster-causing range; and the meteorological data of the grid points includes a wind speed of each grid point and a rainfall amount of each grid point.

The threshold determining module is configured to determine, based on historical typhoon data, disaster-causing thresholds for the meteorological data of the grid points; and the disaster-causing thresholds include: a wind speed disaster-causing threshold and a rainfall disaster-causing threshold.

The data processing module is configured to construct a multi-dimensional feature identification model of the disaster-causing cyclone by using the disaster-causing thresholds, the disaster-causing range, and the meteorological data of the grid points. The data processing module is specifically configured to: mark the grid points whose wind speeds each exceed the wind speed disaster-causing threshold as wind-exceeding grid points, group the consecutive wind-exceeding grid points into a same area to form multiple extreme wind speed influence areas, mark the grid points whose rainfall amounts each exceed the rainfall disaster-causing threshold as rain-exceeding grid points, group the consecutive rain-exceeding grid points into a same area to form multiple extreme rainfall influence areas, determine whether the wind speed and the rainfall amount of each grid point respectively exceed the wind speed disaster-causing threshold and the rainfall disaster-causing threshold at each moment according to the disaster-causing range until no extreme wind speed influence area and no extreme rainfall influence area appear at a certain moment, and obtain a duration of the disaster-causing cyclone based on a number of determined moments; and construct a multi-dimensional feature database for disaster-causing events based on the extreme wind speed influence areas, the extreme rainfall influence areas, the duration, and the path.

The data outputting module is configured to perform multi-dimensional feature identification on the disaster-causing cyclone based on the multi-dimensional feature database for disaster-causing events.

Each of the data obtaining module, the threshold determining module, the data processing module, and the data outputting module is embodied by software stored in at least one memory and executable by at least one processor.

The system can identify the influence range and intensity of near-surface gale and heavy rainfall caused by the disaster-causing cyclone on a time scale, and give the influence range, duration and intensity change of the disaster-causing cyclone in time and accurately, so as to realize intelligent identification and rapid identification of multi-dimensional features of the disaster-causing cyclone.

In the third aspect, the disclosure further provides a computer device, the computer device includes: one or more processors, a memory, and one or more programs, the one or more programs are stored in the memory and configured to be executed by the one or more processors, and the one or more programs, when executed by the one or more processors, implement the steps of the multi-dimensional feature identification method according to the first aspect.

In the fourth aspect, the disclosure further provides a computer-readable storage medium, stored with a computer program therein, and the computer program, when executed by a processor, implements the steps of the multi-dimensional feature identification method according to the first aspect.

### BRIEF DESCRIPTION OF DRAWINGS

FIG. 1 illustrates a schematic flowchart of a multi-dimensional feature identification method of disaster-causing cyclones according to an embodiment of the disclosure.

FIG. 2 illustrates a schematic diagram of a multi-dimensional feature identification model of disaster-causing cyclones according to an embodiment of the disclosure.

FIG. 3 illustrates a schematic structural diagram of a multi-dimensional feature identification system of disaster-causing cyclones according to an embodiment of the disclosure.

### DETAILED DESCRIPTION OF EMBODIMENTS

The technical schemes in the embodiments of the disclosure will be described clearly and completely with the attached drawings.

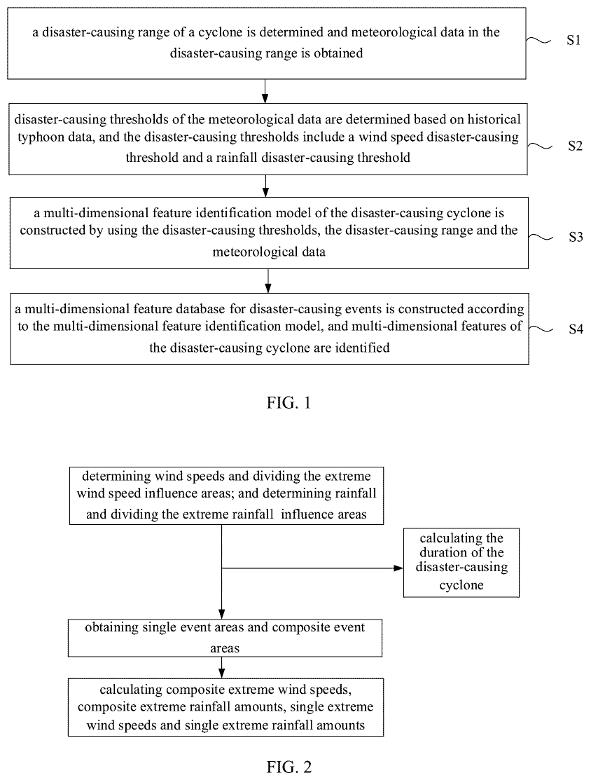

Referring to FIG. 1, the disclosure provides a multi-dimensional feature identification method of disaster-causing cyclones, which includes the following steps S1 to S4.

Step S1, a disaster-causing range of a cyclone is determined and meteorological data in the disaster-causing range is obtained.

According to the embodiment of the disclosure, the disaster-causing range of the cyclone is determined based on a path of the cyclone (also referred to as cyclone path), which specifically includes the following steps S11 to S13.

S11, a buffer distance of the cyclone is set.

The buffer distance is set to ensure that a disaster-affected area actually caused by the disaster-causing cyclone does not exceed the disaster-causing range. In this embodiment, 100 km is set as the buffer distance of the cyclone, so as to obtain a complete disaster-affected area and improve the accuracy of multi-dimensional feature identification of the disaster-causing cyclone.

In other embodiments, another value of the buffer distance can be set.

S12, the cyclone path is identified at every moment.

In this embodiment, based on the real-time path of the disaster-causing cyclone released by the meteorological observatory, a travel route of the disaster-causing cyclone is obtained at regular intervals, the travel route is the cyclone path, and the number of times of obtaining the travel route of the disaster-causing cyclone is recorded.

Optionally, the travel route of the disaster-causing cyclone is obtained once every 10 minutes. In other alternative embodiments, the travel route of the disaster-causing cyclone can also be obtained once every 5 minutes, 15 minutes or 20 minutes, but the interval should not be too long, so as to obtain the accurate duration of the disaster-causing cyclone.

S13, the disaster-causing range is determined by combining the buffer distance and the cyclone path.

In this embodiment, since 100 km is selected as the buffer distance, the range of 100 km around the cyclone path is regarded as the disaster-causing range.

According to the embodiment of the disclosure, obtaining the meteorological data in the disaster-causing range includes: dividing the disaster-causing range into multiple grid points and obtaining meteorological data of each grid point. More specifically, obtaining the meteorological data in the disaster-causing range includes the following steps S1a to S1c.

S1a, a rectangular coordinate system is established with a location where the disaster-causing cyclone is generated as a coordinate origin.

Considering that the disaster-causing cyclone does not have to land to bring direct economic losses, establishing the rectangular coordinate system with the location where the disaster-causing cyclone is generated as the coordinate origin can obtain the most complete disaster-causing range and improve the accuracy of multi-dimensional feature identification of the disaster-causing cyclone.

S1b, the grid points in the disaster-causing range are extracted according to the rectangular coordinate system.

Because the influence of the disaster-causing cyclone is often extensive and rapid, it is impossible to conduct detailed research on all areas within the disaster-causing range in a short time in order to obtain absolutely detailed data to reflect the multi-dimensional features of the disaster-causing cyclone. Therefore, the grid points in the disaster-causing range are extracted according to the rectangular coordinate system, and the influence of the disaster-causing cyclone on the grid points is used to reflect the influence of the disaster-causing cyclone on a certain area, which can not only improve the efficiency of data acquisition, but also ensure the representativeness of the data and accurately reflect the influence of the disaster-causing cyclone on various positions in the disaster-causing range in a large range.

S1c, the meteorological data is extracted within the disaster-causing range based on the grid points, and the meteorological data includes the wind speed of each grid point and the rainfall amount of each grid point.

The influence degree and range of the disaster-causing cyclone are mainly influenced by the wind speed and the rainfall amount, so obtaining the wind speed and the rainfall amount of each grid point is conducive to reflecting the influence range, intensity change and duration of the disaster-causing cyclone on a time scale, thereby realizing the multi-dimensional feature identification of the disaster-causing cyclone.

In this embodiment, the wind speed is obtained according to the real-time measurement of the anemometer tower, and the rainfall amount is obtained through manual measurement. In other alternative embodiments, the wind speed and the rainfall amount can also be obtained in other ways.

S2, disaster-causing thresholds of the meteorological data are determined based on historical typhoon data, and the disaster-causing thresholds include a wind speed disaster-causing threshold and a rainfall disaster-causing threshold.

According to the embodiment of the disclosure, the historical typhoon data includes wind speed disaster-causing grid points, rainfall disaster-causing grid points, grid point wind speeds, grid point rainfall amounts, economic exposure of the disaster-causing cyclone, a direct economic loss caused by typhoon and a total production value.

In this embodiment, the historical typhoon data is obtained based on the sixth typhoon “Fireworks” in 2021, and the historical typhoon data is obtained by querying in the meteorological science data center. In other alternative embodiments, the historical typhoon data can also be obtained based on one or more typhoons in other areas, and the historical typhoon data can also be obtained by other methods and ways.

Determining the disaster-causing thresholds of the meteorological data according to the historical typhoon data specifically includes: obtaining the wind speed disaster-causing threshold according to the historical typhoon data and obtaining the rainfall disaster-causing threshold according to the historical typhoon data.

According to the embodiment of the disclosure, the wind speed disaster-causing threshold satisfies the following relationship:

$${V}_{t} = {[ \frac{L}{E ( {P}^{b} + {G}^{c} )} \times {e}^{\frac{D}{{a}^{2}}} ]}^{\frac{1}{a}} , \\ P = \frac{1}{N} {{\sum }_{i = 1}}^{N} {P}_{\text{?}} ,$$

$$\text{?} \text{indicates text missing or illegible when filed}$$

Where Vₜ represents the wind speed disaster-causing threshold, L represents the direct economic loss caused by typhoon, E represents the economic exposure of the disaster-causing cyclone, P represents a rainfall amount corresponding to the wind speed disaster-causing grid points, G represents the total production value, D represents a constant, a, b, and c are correlation coefficients, N represents a total number of the wind speed disaster-causing grid points, and Pᵢ represents a rainfall amount corresponding to an i-th wind speed disaster-causing grid point.

In this embodiment, based on a historical typhoon, the accuracy of the wind speed disaster-causing threshold has been ensured, because in general, the wind speed that will cause disasters is relatively stable and will not change greatly because of the intensity and number of disaster-causing cyclones.

More specifically, the wind speed disaster-causing grid points are obtained according to the influence range of the historical typhoon, and the influence of the rainfall amount of the grid points is considered according to the typhoon disaster-causing actual situation when calculating the wind speed disaster-causing threshold.

Furthermore, in other alternative embodiments, if multiple historical typhoons are selected as the basis to obtain the wind speed disaster-causing threshold, it is necessary to calculate the wind speed disaster-causing threshold corresponding to each historical typhoon, and then take the average or median of all the wind speed disaster-causing thresholds as the final wind speed disaster-causing threshold.

According to the embodiment of the disclosure, the rainfall disaster-causing threshold satisfies the following relationship:

$${P}_{t} = {[ \frac{L}{E ( {V}^{a} + {G}^{\text{?}} )} \times {e}^{\frac{F}{{}_{b} 2}} ]}^{\frac{1}{\text{?}}} , \\ V = \frac{1}{M} {\sum }_{j = 1}^{M} {V}_{j} .$$

$$\text{?} \text{indicates text missing or illegible when filed}$$

Where Pₜ represents the rainfall disaster-causing threshold, V represents a wind speed corresponding to the rainfall disaster-causing grid points, F is a constant, M represents a total number of the rainfall disaster-causing grid points, and Vⱼ represents a wind speed corresponding to a j-th rainfall disaster-causing grid point.

In this embodiment, based on a historical typhoon, the accuracy of the rainfall disaster-causing threshold has been ensured, because in general, the rainfall amount that will cause disasters is relatively stable and will not change greatly due to the intensity and number of disaster-causing cyclones.

More specifically, the rainfall disaster-causing grid points are obtained according to the influence range of the historical typhoon, and the influence of the wind speed of the grid points is considered according to the typhoon disaster-causing actual situation when calculating the rainfall disaster-causing threshold value.

Furthermore, in other alternative embodiments, if multiple historical typhoons are selected as the basis to obtain the rainfall disaster-causing threshold, it is necessary to calculate the rainfall disaster-causing threshold corresponding to each historical typhoon, and then take the average or median of all rainfall disaster-causing thresholds as the final rainfall disaster-causing threshold.

Step S3, a multi-dimensional feature identification model of the disaster-causing cyclone is constructed by using the disaster-causing thresholds, the disaster-causing range and the meteorological data.

Referring to FIG. 2, according to the embodiment of the disclosure, constructing the multi-dimensional feature identification model includes the following steps S31 to S35.

S31, the grid points whose the wind speeds each exceed the wind speed disaster-causing threshold are determined and recorded as wind-exceeding grid points, and the continuous wind-exceeding grid points are grouped into the same area to form multiple extreme wind speed influence areas.

In this embodiment, within the disaster-causing range, disaster areas affected by the wind speed are not a continuous whole, but is divided into multiple discontinuous areas under the influence of the path of geographical factors. Using the continuity of the locations of the wind-exceeding grid points to obtain the extreme wind speed influence areas can well reflect the disaster-causing situation caused by the wind speed in different locations of the disaster-causing cyclone, and it is convenient to analyze the intensity change and duration of the disaster-causing cyclone.

S32, the grid points whose the rainfall amounts each exceed the rainfall disaster-causing threshold are determined and recorded as rain-exceeding grid points, and the continuous rain-exceeding grid points are grouped into the same area to form multiple extreme rainfall influence areas.

In this embodiment, within the disaster-causing range, disaster areas affected by the rainfall amount is not a continuous whole, but is divided into multiple discontinuous areas under the influence of the path of geographical factors. Using the continuity of the locations of the rain-exceeding grid points to obtain the extreme rainfall influence areas can well reflect the disaster-causing situation of the disaster-causing cyclone caused by the rainfall amount at different locations, which is convenient for analyzing the intensity change and duration of the disaster-causing cyclone.

S33, the wind speed and the rainfall amount of each grid point are determined at each moment according to the disaster-causing range until there is no extreme wind speed influence area and no extreme rainfall influence area at a certain moment, and the duration of the disaster-causing cyclone is obtained according to the number of determined moments.

In this embodiment, with the movement of the disaster-causing cyclone, the intensity of the disaster-causing cyclone will gradually weaken and eventually dissipate, so the extreme wind speed influence area and the extreme rainfall influence area will gradually decrease and eventually disappear, thus the duration of the disaster-causing cyclone can be obtained by judging whether the extreme wind speed influence area and the extreme rainfall influence area exist at a certain moment.

According to the embodiment of the disclosure, the duration of the disaster-causing cyclone is a product of the number of observations (i.e., the number of determined moments) and the data acquisition time interval, and the data acquisition time interval in this embodiment is 10 minutes.

S34, composite event areas and single event areas are extracted by using the extreme wind speed influence areas and the extreme rainfall influence areas, each composite event area is an overlapping area of the extreme wind speed influence area and the extreme rainfall influence area, and each single event area is a non-overlapping area of the extreme wind speed influence area and the extreme rainfall influence area.

In this embodiment, the single event area is only affected by one factor of the wind speed and the rainfall amount, while the composite event area is affected by both the wind speed and the rainfall amount. Extracting the composite event areas and the single event areas by using the extreme wind speed influence areas and the extreme rainfall influence areas is beneficial to reflect the influence degree of the disaster-causing cyclone on different areas and the intensity change of the disaster-causing cyclone in more detail.

S35, according to the wind speeds of the wind-exceeding grid points, a composite extreme wind speed of each composite event area and a single extreme wind speed of each single event area are calculated, and the composite extreme wind speed and the single extreme wind speed respectively satisfy the following relationships:

$${v}_{c} = \frac{1}{{N}_{1}} {\sum }_{i = 1}^{{N}_{1}} {v}_{ci} - {[ \frac{1}{{N}_{1}} {\sum }_{i = 1}^{{N}_{1}} {( {v}_{ci} - \frac{1}{{N}_{1}} {\sum }_{i = 1}^{{N}_{1}} {v}_{\text{?} i} )}^{2} ]}^{\frac{1}{2}} , \\ {v}_{\text{?}} = \frac{1}{{M}_{1}} {\sum }_{j = 1}^{{M}_{1}} {v}_{sj} - {[ \frac{1}{{M}_{1}} {\sum }_{j = 1}^{{M}_{1}} {( {v}_{sj} - \frac{1}{{M}_{1}} {\sum }_{j = 1}^{{M}_{1}} {v}_{sj} )}^{2} ]}^{\frac{1}{2}} .$$

$$\text{?} \text{indicates text missing or illegible when filed}$$

Where v_{c} represents the composite extreme wind speed, N₁ represents a number of grid points in the composite event area, v_{ci} represents a wind speed of the i-th grid point in the composite event area; vₛ represents the single extreme wind speed, M₁ represents a number of grid points of the single event area in the extreme wind influence area, vₛⱼ represents a wind speed of the j-th grid point of the single event area in the extreme wind influence area.

In this embodiment, when calculating the single extreme wind speed, because the disaster situation is only affected by the wind speed, the influence of the rainfall amount is not considered in the calculation. When calculating the composite extreme wind speed, because the wind speed disaster-causing threshold has taken into account the influence of the rainfall amount, and the wind-exceeding grid points are obtained according to the wind speed disaster-causing threshold, it is not necessary to consider the influence of the rainfall amount, thus simplifying the calculation method, improving the calculation efficiency, and facilitating the identification of the intensity of near-surface gale and heavy rainfall caused by the disaster-causing cyclone in the composite event area, as well as the efficient and rapid identification of the intensity change of the disaster-causing cyclone.

S36, according to the rainfall amounts of the rainfall-exceeding grid points, a composite extreme rainfall amount of each composite event area and a single extreme rainfall amount of each single event area are calculated, and the composite extreme rainfall amount and the single extreme rainfall amount satisfy the following relationships respectively:

$${p}_{c} = \frac{1}{{N}_{2}} {\sum }_{i = 1}^{{N}_{2}} {p}_{ci} - {[ \frac{1}{{N}_{2}} {\sum }_{i = 1}^{{N}_{2}} {( {p}_{ci} - \frac{1}{{N}_{2}} {\sum }_{i = 1}^{{N}_{2}} {p}_{ci} )}^{2} ]}^{\frac{1}{2}} , \\ {p}_{s} = \frac{1}{{M}_{2}} {\sum }_{j = 1}^{{M}_{2}} {p}_{sj} - {[ \frac{1}{{M}_{2}} {\sum }_{j = 1}^{{M}_{2}} {( {p}_{sj} - \frac{1}{{M}_{2}} {\sum }_{j = 1}^{{M}_{2}} {p}_{sj} )}^{2} ]}^{\frac{1}{2}} .$$

Where p_{c} represents the composite extreme rainfall amount, N₂ represents a number of grid points in the composite event area, p_{c}, represents a rainfall amount of the i-th grid point in the composite event area, pₛ represents the single extreme rainfall amount, M₂ represents a number of grid points of the single event area in the extreme rainfall influence area, and pₛⱼ represents a rainfall amount of the j-th grid point of the single extreme area in the extreme rainfall influence area.

In this embodiment, when calculating the single extreme rainfall amount, because the disaster situation is only affected by the rainfall amount, the influence of wind speed is not considered in the calculation. When calculating the compound extreme rainfall amount, the influence of wind speed has been taken into account in the rainfall disaster-causing threshold, and the rainfall-exceeding grid points are obtained according to the rainfall disaster-causing threshold, so the influence of wind speed is not needed to be considered, which simplifies the calculation method, improves the calculation efficiency, and is convenient for identifying the intensity of near-surface gale and heavy rainfall caused by the disaster-causing cyclone in the single event area, as well as identifying the intensity change of the disaster-causing cyclone efficiently and quickly.

S4, a multi-dimensional feature database for disaster-causing events is constructed according to the multi-dimensional feature identification model, and multi-dimensional features of the disaster-causing cyclone are identified.

According to the embodiment of the disclosure, the extreme wind speed influence areas, the extreme rainfall influence areas and the duration of the disaster-causing cyclone obtained based on the steps S31-S33 can be used as features in the multi-dimensional feature database for disaster-causing events, and from these features, the accurate influence range and the moment-by-moment intensity change of the disaster-causing cyclone can be identified.

Furthermore, the multi-dimensional feature database for disaster-causing events also includes a multi-dimensional feature database for composite disaster-causing events and a multi-dimensional feature database for single disaster-causing events. Using the multi-dimensional feature database for composite disaster-causing events and the multi-dimensional feature database for single disaster-causing events, the disaster-causing cyclone can be described more carefully and comprehensively, providing more abundant and accurate technical support for disaster early warning.

According to the embodiment of the disclosure, constructing the multi-dimensional feature database for composite disaster-causing events according to the composite event areas includes the following steps S41 to S43.

S41, the composite event areas are numbered in sequence according to the cyclone path to obtain a first set of numbers.

S42, a composite area size of each composite event area, and the composite extreme wind speed and the composite extreme rainfall amount of each composite event area are obtained in sequence according to the first set of numbers.

In this embodiment, a size of each compound event area, that is, the composite area size, is obtained sequentially according to the first set of numbers, which is beneficial to reflect the intensity change of the cyclone on a time scale in detail.

S43, multiple feature subsets for the composite event areas are constructed by using the composite event areas, the composite area sizes, the composite extreme wind speeds and the composite extreme rainfall amounts.

In this embodiment, the compound event area together with the size of the compound event area as well as the compound extreme wind speed and the compound extreme rainfall amount in this compound event area can reflect the intensity of the disaster-causing cyclone when it affects the compound event area to a certain extent, so it is beneficial to more clearly reflect the intensity change of the disaster-causing cyclone and the change of the affected area of the disaster-causing cyclone caused by each compound event area and its corresponding compound area size, compound extreme wind speed and compound extreme rainfall amount to establish the features subsets for the compound event areas.

S44, according to the feature subsets for the composite event areas, the multi-dimensional feature database for composite disaster-causing events is constructed in combination with the path and the duration.

In this embodiment, all the feature subsets for the composite event areas are aggregated together, and the multi-dimensional feature database for the composite disaster-causing events is constructed by combining the path and the duration, so that the data obtained according to the composite event areas is more organized, and the influence range, intensity change and duration of the disaster-causing cyclone can be comprehensively reflected according to the multi-dimensional feature database for composite disaster-causing events.

According to the embodiment of the disclosure, constructing the multi-dimensional feature database for single disaster-causing events according to the single event areas includes the following steps S4a to S4d.

S4a, the single event areas are sequentially numbered according to the path to obtain a second set of numbers.

S4b, a single area size of each single event area and the single extreme wind speed and single extreme rainfall amount of each single event area are sequentially obtained according to the second set of numbers.

In this embodiment, a size of each single event area, that is, the single area size, is obtained according to the second set of numbers, which is beneficial to reflect the intensity change of the disaster-causing cyclone on a time scale in detail.

S4c, multiple feature subsets for the single event areas are constructed by using the single event areas, the single area sizes, the single extreme wind speeds and the single extreme rainfall amount.

In this embodiment, the single event area together with the size of the single event area as well as the single extreme wind speed and the single extreme rainfall amount in the single event area can reflect the intensity of the disaster-causing cyclone when it affects the single event area to a certain extent, so it is beneficial to more clearly reflect the intensity change of the disaster-causing cyclone and the change of the affected area of the disaster-causing cyclone caused by each single event area and its corresponding single area size, single extreme wind speed and single extreme rainfall amount to establish the feature subsets for the single event areas.

S4d, according to the feature subsets for the single event areas, the multi-dimensional feature database for single disaster-causing events is constructed in combination with the path and the duration.

In this embodiment, all the feature subsets for the single event areas are aggregated together, and the multi-dimensional feature database for the single disaster-causing events is constructed by combining the path and the duration, so that the data obtained from the single event areas is more organized, and the influence range, intensity change and duration of the disaster-causing cyclone can be comprehensively reflected according to the multi-dimensional feature database for single disaster-causing events.

Combining the multi-dimensional feature database for composite disaster-causing events with the multi-dimensional feature database for single disaster-causing events can further identify the multi-dimensional features of “path-disaster range-intensity change-duration” of the disaster-causing cyclone.

It should be noted that in some cases, the actions described in the specification can be performed in different orders and still achieve the desired results. In this embodiment, the sequence of steps is only given to make the embodiment clearer and more convenient to explain, but not to limit it.

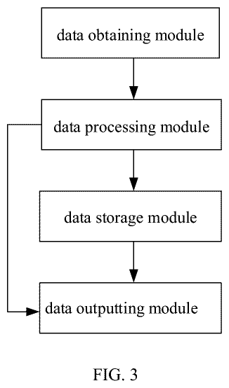

Referring to FIG. 3, according to another embodiment of the disclosure, a multi-dimensional feature identification system of disaster-causing cyclones is provided, which includes a data obtaining module, a data processing module, a data storage module and a data outputting module.

The data obtaining module is configured to obtain the historical typhoon data, the disaster-causing range and the meteorological data.

In some embodiments, the historical typhoon data includes wind speed disaster-causing grid points, rainfall disaster-causing grid points, grid point wind speeds, grid point rainfall amounts, economic exposure of the disaster-causing cyclone, a direct economic loss caused by typhoon and a total production value. The historical typhoon data is obtained by querying in the meteorological science data center. The disaster-causing range can be obtained by setting the buffer distance on the basis of the path of the disaster-causing cyclone. The meteorological data includes the wind speed and the rainfall amount of each grid point. The wind speed can be obtained by real-time measurement of the anemometer tower, and the rainfall amount can be obtained by manual measurement.

The data processing module is connected with the data obtaining module, and the data processing module is configured to receive the data in the data obtaining module, obtain the disaster-causing thresholds, and constructing the multi-dimensional feature identification model, and then constructing the multi-dimensional feature database for disaster-causing events according to the multi-dimensional feature identification model.

In an alternative embodiment, the disaster-causing thresholds are determined by a threshold determining module, which is configured to determine the disaster-causing thresholds of the meteorological data based on the historical typhoon data, the disaster-causing thresholds include the wind speed disaster-causing threshold and the rainfall disaster-causing threshold. The specific calculation method of the thresholds can refer to the description in the above-mentioned method embodiment, and will not be repeated here.

According to the embodiment of the disclosure, the data processing module is configured to construct the multi-dimensional feature identification model of the disaster-causing cyclone by using the disaster-causing thresholds, the disaster-causing range, and the meteorological data of the grid points. Specifically, the data processing module is configured to: mark the grid points whose wind speeds each exceed the wind speed disaster-causing threshold as wind-exceeding grid points, group the consecutive wind-exceeding grid points into a same area to form multiple extreme wind speed influence areas, mark the grid points whose rainfall amounts each exceed the rainfall disaster-causing threshold as rain-exceeding grid points, group the consecutive rain-exceeding grid points into a same area to form multiple extreme rainfall influence areas, determine whether the wind speed and the rainfall amount of each grid point respectively exceed the wind speed disaster-causing threshold and the rainfall disaster-causing threshold at each moment according to the disaster-causing range until no extreme wind speed influence area and no extreme rainfall influence area appear at a certain moment, and obtain a duration of the disaster-causing cyclone based on a number of determined moments.

The data processing module is further configured to construct the multi-dimensional feature database for disaster-causing events based on the extreme wind speed influence areas, the extreme rainfall influence areas, the duration, and the path.

In an alternative embodiment, the data processing module is further configured to extract composite event areas and single event areas based on the extreme wind speed influence areas and the extreme rainfall influence areas. The composite event areas respectively are overlapping areas between the extreme wind speed influence areas and the extreme rainfall influence areas, and the single event areas respectively are non-overlapping areas between the extreme wind speed influence areas and the extreme rainfall influence areas. The data processing module is further configured to calculate a composite extreme wind speed of each composite event area and a single extreme wind speed of each single event area, and calculate a composite extreme rainfall amount of each composite event area and a single extreme rainfall amount of each single event area. The multi-dimensional feature database for disaster-causing events includes a multi-dimensional feature database for composite disaster-causing events and a multi-dimensional feature database for single disaster-causing events. The specific calculation method and database construction can refer to the description of the above-mentioned method embodiment, and will not be repeated here.

The data storage module is connected with the data processing module and configured to store data in the data processing module.

The data outputting module is connected with the data processing module and the data storage module, and is configured to output data in the data processing module and the data storage module, and realize multi-dimensional feature identification of the disaster-causing cyclone according to the output data.

To sum up, the method provided by the disclosure can identify the influence range and intensity of near-surface gale and heavy rainfall caused by the disaster-causing cyclone on a time scale, accurately give the influence range, duration and intensity change of the disaster-causing cyclone, and provide technical support for further accurately evaluating the socio-economic exposure and vulnerability of the disaster-causing cyclone. In addition, the system provided by the disclosure adapts to the method provided by the disclosure, and realizes intelligent identification and rapid identification of the multi-dimensional features of the disaster-causing cyclone.

The disclosure further provides a computer device, which includes: one or more processors, a memory, and one or more programs. The one or more programs are stored in the memory and configured to be executed by the one or more processors, and the one or more programs, when executed by the one or more processor, implement the steps of the multi-dimensional feature identification method of the disaster-causing cyclone as described above.

The disclosure further provides a computer-readable storage medium, on which a computer program is stored, and when the computer program is executed by a processor, the steps of the multi-dimensional feature identification method of the disaster-causing cyclone are implemented. The computer-readable storage medium may be a non-transitory computer-readable storage medium.

Those skilled in the art will appreciate that embodiments of the disclosure may be provided as a method, system, or computer program product. Therefore, the disclosure can take the form of an entirely hardware embodiment, an entirely software embodiment, or an embodiment combining software and hardware aspects. Furthermore, the disclosure can take the form of a computer program product embodied on one or more computer usable storage media (including but not limited to disk storage, compact disc read-only memory (CD-ROM), optical storage, etc.) containing computer usable program codes therein.

The disclosure is described with reference to flowcharts and/or block diagrams of methods, devices (systems) and computer program products according to embodiments of the disclosure. It should be understood that each flow and/or block in the flowchart and/or block diagram, and combinations of the flow and/or block in the flowchart and/or block diagram can be implemented by computer program instructions. These computer program instructions may be provided to a processor of a general-purpose computer, a special-purpose computer, an embedded processor or other programmable data processing apparatus to produce a machine, such that the instructions executed by the processor of the computer or other programmable data processing apparatus produce means for implementing the functions specified in the one or more flows in the flowchart and/or one or more blocks in the block diagram.

These computer program instructions may also be stored in a computer-readable memory that can direct a computer or other programmable data processing apparatus to function in a particular manner, such that the instructions stored in the computer-readable memory produce an article of manufacture including instruction means that implement the functions specified in one or more flow charts and/or block diagrams.

These computer program instructions may also be loaded onto a computer or other programmable data processing apparatus, such that a series of operational steps are performed on the computer or other programmable apparatus to produce a computer-implemented process, such that the instructions executed on the computer or other programmable apparatus provide steps for implementing the functions specified in the flowchart flow or flows and/or block or blocks of the block diagram.

What is claimed is:

1. A multi-dimensional feature identification method of a disaster-causing cyclone, comprising:
determining a disaster-causing range based on a path of the disaster-causing cyclone, dividing the disaster-causing range into a plurality of grid points, and obtaining meteorological data of the plurality of grid points within the disaster-causing range; wherein the meteorological data of the plurality of grid points comprises a wind speed of each grid point and a rainfall amount of each grid point;
determining, based on historical typhoon data, disaster-causing thresholds for the meteorological data of the plurality of grid points; wherein the disaster-causing thresholds comprise: a wind speed disaster-causing threshold and a rainfall disaster-causing threshold; a calculation formula of the wind speed disaster-causing threshold is as follows:
$${V}_{t} = {[ \frac{L}{E ( {P}^{\text{?}} + {G}^{\text{?}} )} \times {e}^{\frac{D}{{a}^{2}}} ]}^{\frac{1}{a}} ,$$
$$\text{?} \text{indicates text missing or illegible when filed}$$
where Vₜ represents the wind speed disaster-causing threshold, L represents a direct economic loss caused by typhoon, E represents an economic exposure of the disaster-causing cyclone, P represents a rainfall amount corresponding to wind speed disaster-causing grid points,
$$P = \frac{1}{N} {\sum }_{i = 1}^{N} {P}_{i} ,$$
N represents a total number of the wind speed disaster-causing grid points, Pᵢ represents a rainfall amount corresponding to an i-th wind speed disaster-causing grid point of the wind speed disaster-causing grid points, G represents a total production value, D is a constant, and a, b, and c are correlation coefficients; and a calculation formula of the rainfall disaster-causing threshold is as follows:
$${P}_{i} = {[ \frac{L}{E ( {V}^{\text{?}} + {G}^{\text{?}} )} \times {e}^{\frac{F}{{b}^{2}}} ]}^{\frac{1}{b}} ,$$
$$\text{?} \text{indicates text missing or illegible when filed}$$
where Pₜ represents the rainfall disaster-causing threshold, V represents a wind speed corresponding to rainfall disaster-causing grid points,
$$V = \frac{1}{M} {\sum }_{j = 1}^{M} {V}_{j} ,$$
M represents a total number of the rainfall disaster-causing grid points, Vⱼ represents a wind speed corresponding to a j-th rainfall disaster-causing grid point of the rainfall disaster-causing grid points, and F is a constant;
constructing a multi-dimensional feature identification model of the disaster-causing cyclone by using the disaster-causing thresholds, the disaster-causing range, and the meteorological data of the plurality of grid points; wherein the constructing a multi-dimensional feature identification model of the disaster-causing cyclone by using the disaster-causing thresholds, the disaster-causing range, and the meteorological data of the plurality of grid points, comprises the following steps:
marking ones of the plurality of grid points whose wind speeds each exceed the wind speed disaster-causing threshold as wind-exceeding grid points;
grouping consecutive ones of the wind-exceeding grid points into a same area to form a plurality of extreme wind speed influence areas;
marking ones of the plurality of grid points whose rainfall amounts each exceed the rainfall disaster-causing threshold as rain-exceeding grid points;
grouping consecutive ones of the rain-exceeding grid points into a same area to form a plurality of extreme rainfall influence areas;
determining whether the wind speed and the rainfall amount of each grid point respectively exceed the wind speed disaster-causing threshold and the rainfall disaster-causing threshold at each moment according to the disaster-causing range until no extreme wind speed influence area and no extreme rainfall influence area appear at a certain moment;
obtaining a duration of the disaster-causing cyclone based on a number of moments;
extracting composite event areas and single event areas based on the plurality of extreme wind speed influence areas and the plurality of extreme rainfall influence areas; wherein the composite event areas respectively are overlapping areas between the plurality of extreme wind speed influence areas and the plurality of extreme rainfall influence areas, and the single event areas respectively are non-overlapping areas between the plurality of extreme wind speed influence areas and the plurality of extreme rainfall influence areas;
calculating a composite extreme wind speed of each composite event area and a single extreme wind speed of each single event area based on the wind speeds of the wind-exceeding grid points; wherein the composite extreme wind speed of each composite event area and the single extreme wind speed of each single event area respectively satisfy the following relationships:
$${v}_{c} = \frac{1}{{N}_{1}} {\sum }_{i = 1}^{{N}_{1}} {v}_{ci} - {[ \frac{1}{{N}_{1}} {\sum }_{i = 1}^{{N}_{1}} {( {v}_{ci} - \frac{1}{{N}_{1}} {\sum }_{i = 1}^{{N}_{1}} {v}_{ci} )}^{2} ]}^{\frac{1}{2}} ; \\ {v}_{s} = \frac{1}{{M}_{1}} {\sum }_{j = 1}^{{M}_{1}} {v}_{sj} - {[ \frac{1}{{M}_{1}} {\sum }_{j = 1}^{{M}_{1}} {( {v}_{sj} - \frac{1}{{M}_{1}} {\sum }_{j = 1}^{{M}_{1}} {v}_{sj} )}^{2} ]}^{\frac{1}{2}} ;$$
where v_{c} represents the composite extreme wind speed, N₁ represents a number of grid points in the composite event area, v_{ci} represents a wind speed of an i-th grid point in the composite event area; vₛ represents the single extreme wind speed, M₁ represents a number of grid points of the single event area in the extreme wind influence area, and vₛⱼ represents a wind speed of a j-th grid point of the single event area in the extreme wind influence area;
calculating a composite extreme rainfall amount of each composite event area and a single extreme rainfall amount of each single event area based on the rainfall amounts of the rain-exceeding grid points; wherein the composite extreme rainfall amount of each composite event area and the single extreme rainfall amount of each single event area respectively satisfy the following relationships:
$${p}_{c} = \frac{1}{{N}_{2}} {\sum }_{i = 1}^{{N}_{2}} {p}_{ci} - {[ \frac{1}{{N}_{2}} {\sum }_{i = 1}^{{N}_{2}} {( {p}_{ci} - \frac{1}{{N}_{2}} {\sum }_{i = 1}^{{N}_{2}} {p}_{ci} )}^{2} ]}^{\frac{1}{2}} ; \\ {p}_{s} = \frac{1}{{M}_{2}} {\sum }_{j = 1}^{{M}_{2}} {p}_{sj} - {[ \frac{1}{{M}_{2}} {\sum }_{j = 1}^{{M}_{2}} {( {p}_{sj} - \frac{1}{{M}_{2}} {\sum }_{j = 1}^{{M}_{2}} {p}_{sj} )}^{2} ]}^{\frac{1}{2}} ;$$
where p_{c} represents the composite extreme rainfall amount, N₂ represents a number of grid points in the composite event area, p_{ci} represents a rainfall amount of the i-th grid point in the composite event area, pₛ represents the single extreme rainfall amount, M₂ represents a number of grid points of the single event area in the extreme rainfall influence area, and pₛⱼ represents a rainfall amount of the j-th grid point of the single extreme area in the extreme rainfall influence area;
constructing a multi-dimensional feature database for disaster-causing events based on the extreme wind speed influence areas, the extreme rainfall influence areas, the duration, and the path; wherein the constructing a multi-dimensional feature database for disaster-causing events based on the extreme wind speed influence areas, the extreme rainfall influence areas, the duration, and the path comprises: constructing a multi-dimensional feature database for composite disaster-causing events based on the composite event areas, and constructing a multi-dimensional feature database for single disaster-causing events based on the single event areas; and
performing multi-dimensional feature identification on the disaster-causing cyclone based on the multi-dimensional feature database for disaster-causing events.

2. The multi-dimensional feature identification method as claimed in claim 1, wherein the constructing a multi-dimensional feature database for composite disaster-causing events based on the composite event areas, comprises:
sequentially numbering the composite event areas along the path to obtain a first set of numbers;
sequentially obtaining, based on the first set of numbers, a size of each composite event area, the composite extreme wind speed and the composite extreme rainfall amount of each composite event area;
constructing, based on the composite event areas, the size of each composite event area, the composite extreme wind speed and the composite extreme rainfall amount of each composite event area, a plurality of feature subsets for the composite event areas; and
constructing, based on the plurality of feature subsets for the composite event areas, the path and the duration, the multi-dimensional feature database for composite disaster-causing events.

3. The multi-dimensional feature identification method as claimed in claim 1, wherein the constructing a multi-dimensional feature database for single disaster-causing events based on the single event areas, comprises:
sequentially numbering the single event areas along the path to obtain a second set of numbers;
sequentially obtaining, based on the second set of numbers, a size of each single event area, the single extreme wind speed and the single extreme rainfall amount of each single event area;
constructing, based on the single event areas, the size of each single event area, the single extreme wind speed and the single extreme rainfall amount of each single event area, a plurality of feature subsets for the single event areas; and
constructing, based on the plurality of feature subsets for the single event areas, the path and the duration, the multi-dimensional feature database for single disaster-causing events.

4. A multi-dimensional feature identification system of a disaster-causing cyclone, comprising:
a data obtaining module, configured to determine a disaster-causing range based on a path of the disaster-causing cyclone, divide the disaster-causing range into a plurality of grid points, and obtain meteorological data of the plurality of grid points within the disaster-causing range; wherein the meteorological data of the plurality of grid points comprises a wind speed of each grid point and a rainfall amount of each grid point;
a threshold determining module, configured to determine, based on historical typhoon data, disaster-causing thresholds for the meteorological data of the plurality of grid points; wherein the disaster-causing thresholds comprise: a wind speed disaster-causing threshold and a rainfall disaster-causing threshold; a calculation formula of the wind speed disaster-causing threshold is as follows:
$${V}_{t} = {[ \frac{L}{E ( {P}^{b} + {G}^{c} )} \times {e}^{\frac{D}{{a}^{2}}} ]}^{\frac{1}{a}} ,$$
where V₁ represents the wind speed disaster-causing threshold, L represents a direct economic loss caused by typhoon, E represents an economic exposure of the disaster-causing cyclone, P represents a rainfall amount corresponding to wind speed disaster-causing grid points,
$$P = \frac{1}{N} {\sum }_{i = 1}^{N} {P}_{i} ,$$
N represents a total number of the wind speed disaster-causing grid points, Pᵢ represents a rainfall amount corresponding to an i-th wind speed disaster-causing grid point of the wind speed disaster-causing grid points, G represents a total production value, D is a constant, and a, b, and c are correlation coefficients; and a calculation formula of the rainfall disaster-causing threshold is as follows:
$${P}_{t} = {[ \frac{L}{E ( {V}^{a} + {G}^{c} )} \times {e}^{\frac{F}{{}_{b} 2}} ]}^{\frac{1}{b}} ,$$
where Pₜ represents the rainfall disaster-causing threshold, V represents a wind speed corresponding to rainfall disaster-causing grid points,
$$V = \frac{1}{M} {\sum }_{j = 1}^{M} {V}_{j} ,$$
M represents a total number of the rainfall disaster-causing grid points, Vⱼ represents a wind speed corresponding to a j-th rainfall disaster-causing grid point of the rainfall disaster-causing grid points, and F is a constant;
a data processing module, configured to:
mark ones of the plurality of grid points whose wind speeds each exceed the wind speed disaster-causing threshold as wind-exceeding grid points;
group consecutive ones of the wind-exceeding grid points into a same area to form a plurality of extreme wind speed influence areas;
mark ones of the plurality of grid points whose rainfall amounts each exceed the rainfall disaster-causing threshold as rain-exceeding grid points;
group consecutive ones of the rain-exceeding grid points into a same area to form a plurality of extreme rainfall influence areas;
determine whether the wind speed and the rainfall amount of each grid point respectively exceed the wind speed disaster-causing threshold and the rainfall disaster-causing threshold at each moment according to the disaster-causing range until no extreme wind speed influence area and no extreme rainfall influence area appear at a certain moment;
obtain a duration of the disaster-causing cyclone based on a number of moments;
extract composite event areas and single event areas based on the plurality of extreme wind speed influence areas and the plurality of extreme rainfall influence areas; wherein the composite event areas respectively are overlapping areas between the plurality of extreme wind speed influence areas and the plurality of extreme rainfall influence areas, and the single event areas respectively are non-overlapping areas between the plurality of extreme wind speed influence areas and the plurality of extreme rainfall influence areas;
construct a multi-dimensional feature database for disaster-causing events based on the extreme wind speed influence areas, the extreme rainfall influence areas, the duration, and the path; wherein a multi-dimensional feature database for composite disaster-causing events is constructed based on the composite event areas, and a multi-dimensional feature database for single disaster-causing events is constructed based on the single event areas;
calculate a composite extreme wind speed of each composite event area and a single extreme wind speed of each single event area based on the wind speeds of the wind-exceeding grid points; wherein the composite extreme wind speed of each composite event area and the single extreme wind speed of each single event area respectively satisfy the following relationships:
$${v}_{c} = \frac{1}{{N}_{1}} {\sum }_{i = 1}^{{N}_{1}} {v}_{ci} - {[ \frac{1}{{N}_{1}} {\sum }_{i = 1}^{{N}_{1}} {( {v}_{ci} - \frac{1}{{N}_{1}} {\sum }_{i = 1}^{{N}_{1}} {v}_{ci} )}^{2} ]}^{\frac{1}{2}} ; \\ {v}_{s} = \frac{1}{{M}_{1}} {\sum }_{j = 1}^{{M}_{1}} {v}_{sj} - {[ \frac{1}{{M}_{1}} {\sum }_{j = 1}^{{M}_{1}} {( {v}_{sj} - \frac{1}{{M}_{1}} {\sum }_{j = 1}^{{M}_{1}} {v}_{sj} )}^{2} ]}^{\frac{1}{2}} ;$$
where v_{c} represents the composite extreme wind speed, N₁ represents a number of grid points in the composite event area, v_{ci} represents a wind speed of an i-th grid point in the composite event area; vₛ represents the single extreme wind speed, M₁ represents a number of grid points of the single event area in the extreme wind influence area, and vₛⱼ represents a wind speed of a j-th grid point of the single event area in the extreme wind influence area;
calculate a composite extreme rainfall amount of each composite event area and a single extreme rainfall amount of each single event area based on the rainfall amounts of the rain-exceeding grid points; wherein the composite extreme rainfall amount of each composite event area and the single extreme rainfall amount of each single event area respectively satisfy the following relationships:
$${p}_{c} = \frac{1}{{N}_{2}} {\sum }_{i = 1}^{{N}_{2}} {p}_{ci} - {[ \frac{1}{{N}_{2}} {\sum }_{i = 1}^{{N}_{2}} {( {p}_{ci} - \frac{1}{{N}_{2}} {\sum }_{i = 1}^{{N}_{2}} {p}_{ci} )}^{2} ]}^{\frac{1}{2}} ; \\ {p}_{s} = \frac{1}{{M}_{2}} {\sum }_{j = 1}^{{M}_{2}} {p}_{sj} - {[ \frac{1}{{M}_{2}} {\sum }_{j = 1}^{{M}_{2}} {( {p}_{sj} - \frac{1}{{M}_{2}} {\sum }_{j = 1}^{{M}_{2}} {p}_{sj} )}^{2} ]}^{\frac{1}{2}} ;$$
where p_{c} represents the composite extreme rainfall amount, N₂ represents a number of grid points in the composite event area, p_{ci} represents a rainfall amount of the i-th grid point in the composite event area, pₛ represents the single extreme rainfall amount, M₂ represents a number of grid points of the single event area in the extreme rainfall influence area, and pₛⱼ represents a rainfall amount of the j-th grid point of the single extreme area in the extreme rainfall influence area; and
a data outputting module, configured to perform multi-dimensional feature identification on the disaster-causing cyclone based on the multi-dimensional feature database for disaster-causing events.

5. A computer device, comprising:
one or more processors;
a memory; and
one or more programs, wherein the one or more programs are stored in the memory and configured to be executed by the one or more processors, and the one or more programs, when executed by the one or more processors, implement the steps of the multi-dimensional feature identification method as claimed in claim 1.

6. A computer-readable storage medium, stored with a computer program therein, wherein the computer program, when executed by a processor, implements the steps of the multi-dimensional feature identification method as claimed in claim 1.
